(19) United States
(12) Patent Application Publication
(10) Pub. No.: US 2005/0275205 A1
(43) Pub. Date: Dec. 15, 2005

(54) Small diameter steering wheel apparatus

(76) Inventor: Bruce Ahnafield, Indianapolis, IN (US)

Correspondence Address: MAGINOT, MOORE & BECK;BANK ONE CENTER/TOWER, 1111 MONUMENT CIRCLE, INDIANAPOLIS, IN, 46204, US

(21) Appl. No.: 10/903,335

(22) Filed: Jul. 30, 2004

Related U.S. Application Data
(60) Provisional application No. 60/574,502, filed on May 26, 2004.

(51) Int. Cl. B60K 26/00

(52) U.S. Cl. 280/771

(57) ABSTRACT

A steering apparatus is provided for use by a physically challenged driver comprising a steering wheel having a diameter significantly smaller than the diameter of the stock steering wheel and a position encoding mechanism coupled to the steering wheel operable to generate a position signal in relation to the amount of rotation of the steering wheel. This position signal is fed to a processor that is operable to generate a steering command in relation to the position signal, which command directs a steering mechanism to rotate the steering shaft in response thereto. The position encoding mechanism includes a steering gear rotatable with the steering wheel, and at least three driven gears and associated position sensors meshed with the steering gear, operable to provide triple redundancy to the position signal used to generate the steering command. The steering apparatus further comprises a sensitivity mechanism that is operable to produce an adjustable resistance to rotation of the steering wheel.

### CROSS-REFERENCE TO RELATED APPLICATION

The present application claims priority to co-pending provisional application No. 60/574,502, filed on May 26, 2004, the disclosure of which is incorporated herein by reference.

### BACKGROUND OF THE INVENTION

The present invention relates to a system for controlling a motor vehicle, and particularly for operating the vehicle steering. This invention can be readily applied to vehicle control systems for physically impaired drivers.

A conventional motor vehicle, such as an automobile, is designed for a driver having full and substantially unrestricted use of all of their limbs. The standard vehicle controls include a rotary operating steering wheel, a depressible brake pedal, and a depressible accelerator pedal. Of course, it is known that the steering wheel is operated manually, while the brake and accelerator pedals are operated by the driver's feet. Current production vehicles assume that the driver has full use of his/her hands and feet in order to operate these vehicle controls.

Unfortunately, a significant percentage of the driving population does not have full use of all of their limbs. For instance, drivers with certain physical disabilities may be unable to use their legs to operate the brake and accelerator pedals. Although no production vehicles have been developed to account for physically-impaired drivers, a significant amount of effort has been expended in developing systems that can be integrated into an existing vehicle control system to accommodate this driving population. One such system is depicted and described in U.S. Pat. No. 4,722,416, which issued on Feb. 2, 1998 to one of the inventors of the present invention. A system embodying the teachings of the '416 patent has been sold by Ahnafield Corporation as its “Joystick Driving Control™” system. The basic components of this system include a braking/acceleration control system that integrates with the vehicle controls. A joystick controller is provided that can be manually manipulated by the physically-impaired driver. An electronic circuit or microprocessor interprets movement signals from the joystick controller and produces control signals to operate a brake control cylinder and/or an accelerator control cylinder.

In certain applications, the joystick controller is a two-axis joystick such that movement in one direction or axis, such as forward and backward, controls either the brake or accelerator pedal. Movement in a perpendicular direction, say left or right, is used to operate the steering in lieu of the traditional steering wheel.

While the Joystick Driving Control™ vehicle control system has been very successful in improving the freedom and mobility of the physically-impaired driver, there is always room for improvement. For instance, not all physically impaired drivers require a joystick for steering control. These drivers have sufficient dexterity to manipulate a steering wheel, but may lack the ability to rotate and control a traditional vehicle steering wheel. For instance, most traditional steering wheels have a diameter of at least 12 inches. Some drivers cannot rotate a steering wheel of this size through its full range of motion. In other cases, even with a power steering assist, some driver lack the strength or mobility to move the steering wheel easily. Thus, there remains a need for improvements to vehicle steering systems, particularly those intended for use by the physically-impaired driver.

### SUMMARY OF THE INVENTION

To address this continuing need, the present invention provides a system for use by a physically impaired driver for controlling the steering functions of a vehicle. In one embodiment, the system includes a small diameter steering wheel that can be easily manipulated by drivers with limited manual dexterity, strength and mobility. The steering wheel drives a steering gear and a sensitivity gear. The steering gear meshes with one or more driven gears that convert the rotation of the steering wheel into a rotational position signal. In the preferred embodiment, the driven gear(s) is connected to a position sensor, such as a potentiometer, that produces a signal in response to the rotational position of the driven gear. This signal is fed to a controller that generates a control signal in response to the rotational position signal(s). This control signal is fed to a mechanism linked to the existing vehicle steering shaft that rotates the shaft as if the existing vehicle steering wheel was being rotated.

In one aspect of the invention, the steering apparatus includes a mechanism for adjusting the amount of resistance to rotation of the steering wheel. The resistance can require as little as one ounce of effort to rotate the small diameter steering wheel. In the preferred embodiment, the sensitivity gear meshes with a reaction gear. A pressure screw bears against a reaction surface of the reaction gear to provide adjustable frictional resistance to rotation of the gear. The amount of effort required to rotate the steering wheel can thus be varied by adjusting the amount of pressure exerted by the pressure screw. In addition, the effort can be adjusted by changing the gear ratio between the sensitivity gear and the reaction gear.

In one embodiment of the invention, a steering apparatus is provided for use in a vehicle having a stock steering wheel and steering shaft rotatably coupled to the stock steering wheel. The apparatus is especially configured for use by a differently abled driver and comprises a steering wheel having a diameter significantly smaller than the diameter of the stock steering wheel. The apparatus further includes a position encoding mechanism coupled to the steering wheel and operable to generate a position signal in relation to the amount of rotation of the steering wheel. This position signal is fed to a processor that is operable to generate a steering command in relation to the position signal. This steering command directs a steering mechanism coupled to the vehicle steering shaft to rotate the steering shaft in response to the steering command.

In one feature of the invention, the position encoding mechanism includes a steering gear connected to the steering wheel to rotate therewith, at least three driven gears meshed with the steering gear, and at least three sensors, each coupled to a respective one of the driven gears and operable to generate a position signal in relation to the amount of rotation of the respective driven gear. In certain embodiments of the invention, the processor is configured to poll the position signal generated by each of the at least three sensors and to produce a single steering command in relation thereto. The polling process is adapted to provide triple redundancy to avoid the risk of an erroneous position signal causing a faulty steering command.

In a further feature of the invention, the steering apparatus further comprises a sensitivity mechanism coupled to the steering wheel. The sensitivity mechanism is operable to produce a resistance to rotation of the steering wheel based on the physical abilities and preferences of the driver. In one embodiment, the sensitivity mechanism includes a reaction gear coupled to the steering wheel to rotate therewith and a pressure element bearing against the reaction gear to frictionally resist rotation of the reaction gear. The pressure element is preferably a screw mounted relative to the reaction gear to apply an adjustable pressure against the reaction gear.

In another aspect of the invention, the steering apparatus further comprises a housing enclosing the position encoding mechanism and a mounting system for mounting the housing within the vehicle for access by the vehicle's driver. The mounting system may include a mounting bar mountable to the vehicle and a support bar having one end in telescoping engagement with the mounting bar and another end connected to the housing. The mounting system is configured to provide multiple degree of freedom positioning of the steering apparatus for the convenience and comfort of the driver. The mounting system is further configured to support the steering apparatus clear of the stock steering wheel of the vehicle so that a different driver can still operate the vehicle using its stock controls.

It is one object of the invention to provide a system that can be easily managed by a person having a physical disability that might otherwise prevent that person from operating a motor vehicle. One important object is to provide such a system that can provide that driver with the greatest ability to control the vehicle steering while taking into account the physical limitations of that driver. These and other objects, as well as many benefits of the present invention, will become apparent upon consideration of the following written description, taken together with the accompanying figures.

### DESCRIPTION OF THE FIGURES

FIG. 1 is a perspective view of the components of a vehicle steering system in accordance with one embodiment of the invention.

FIG. 2 is a side elevational view of a small diameter steering apparatus in accordance with one embodiment of the present invention.

FIG. 3 is an end elevational view of the small diameter steering apparatus shown in FIG. 2.

FIG. 4 is a bottom elevational view of the small diameter steering apparatus shown in FIG. 3.

FIG. 5 is a perspective view of a steering assembly for use with the small diameter steering apparatus depicted in FIG. 2.

FIG. 6 is a perspective view of the steering assembly rotated 90° relative to the view depicted in FIG. 5.

FIG. 7 is a front perspective view of a driver's cockpit in a motor vehicle showing a system for mounting the small diameter steering apparatus of the present invention.

FIG. 8 is a top perspective view of a mounting assembly for use with the mounting system of FIG. 7.

### DESCRIPTION OF THE PREFFERED EMBODIMENTS

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

The present invention contemplates a novel small diameter steering apparatus 10 that forms part of a vehicle control system, as depicted in FIG. 1. The control system includes the small diameter steering wheel 12 which is manually manipulated by the vehicle operator to provide control signals to a microprocessor or electronic control unit 22. The control unit 22 processes the signals received from the steering apparatus 10 and transmits appropriate control signals to a steering mechanism 20. Electrical power to the system is supplied to the control unit 22 from a power supply 26 that includes the primary vehicle battery and a back-up battery. Optionally, and preferably, the control unit 22 is activated by a key operated switch 24. Details of the control unit 22, steering assembly 22 and the other components 24-26 can be obtained from co-pending application Ser. No. 10/______, filed concurrently with the present application and claiming priority to co-pending provisional application No. 60/491,740, which was filed on Aug. 1, 2003. The disclosure of co-pending application Ser. No. 10/______ and provisional application No. 60/491,740, is incorporated herein by reference.

The small diameter steering apparatus 10 of the present invention includes a small diameter steering wheel 12 with a grip knob 14 mounted thereon, as shown in FIG. 1. The knob is preferably mounted to the wheel by a pivoting bolt assembly 15 that connects the knob 14 to the wheel 12 while allowing the knob to rotate. This auxiliary wheel has a diameter significantly smaller than the diameter of the vehicle's stock steering wheel. In a specific embodiment, the wheel 12 has a diameter of about 6 inches so that the range of motion required for a full turn input is much less than for a traditional steering wheel. In addition, the smaller diameter reduces the moment arm for the steering input, which ultimately reduces the effort that must be exerted by the driver.

The steering apparatus 10 includes a position encoding mechanism 30 for producing a signal in relation to the amount of rotation of the steering wheel 12. The position encoding mechanism 30 is contained within a housing 16 that is compact in size so that it can be mounted in a variety of locations within the driver's cockpit of the automobile. For instance, the housing 16 can be supported on a bracket that extends from the vehicle dashboard or even the steering column. In many instances, the physically challenged driver is seated in a wheel chair that is maneuvered into the driver's cockpit, or the driver is of slight stature. In either case, the traditional placement for the steering wheel usually renders it inaccessible to the physically challenged driver. Thus, the housing 16 can be optimally outfitted for the specific driver when the vehicle is fitted with the steering apparatus 10 of the present invention.

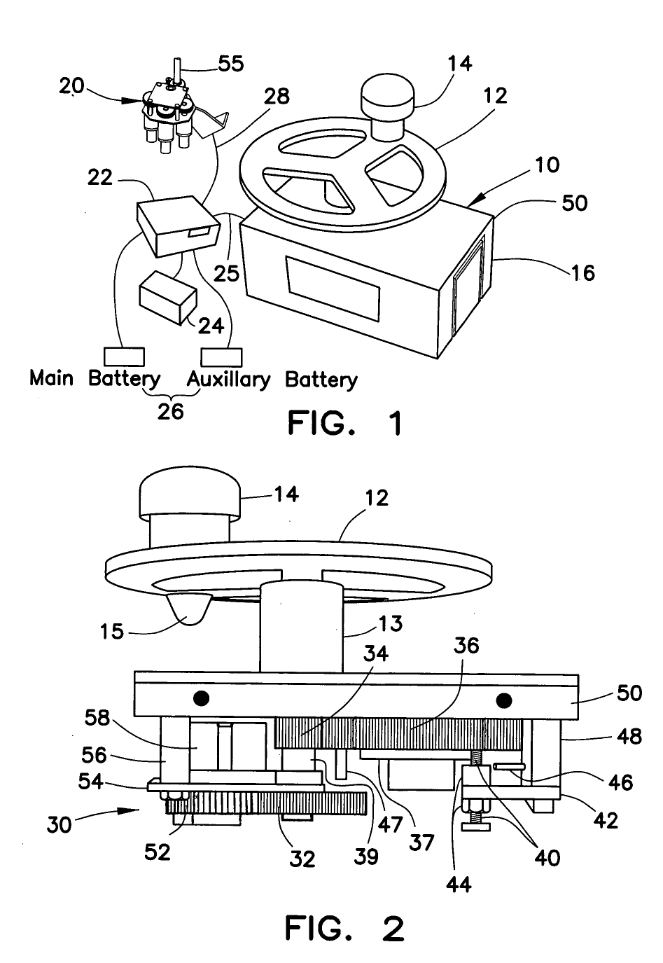

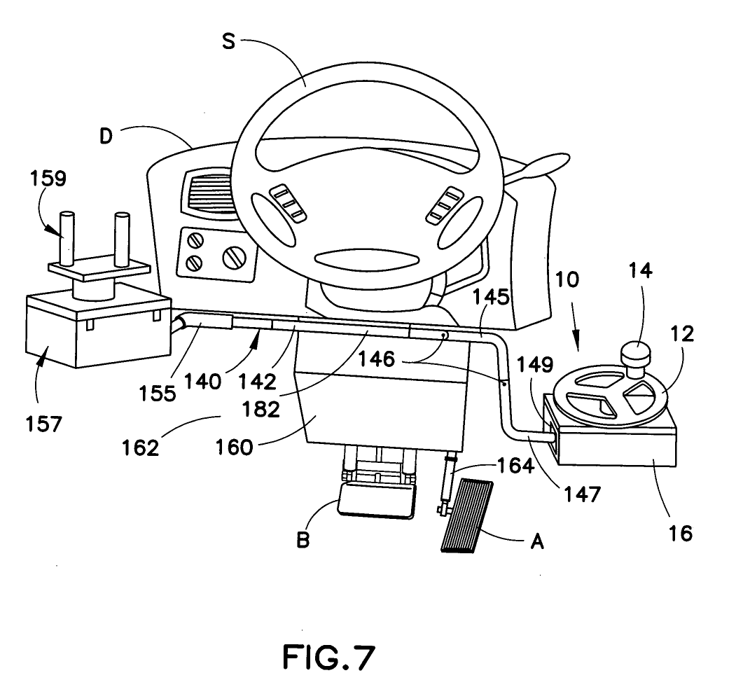

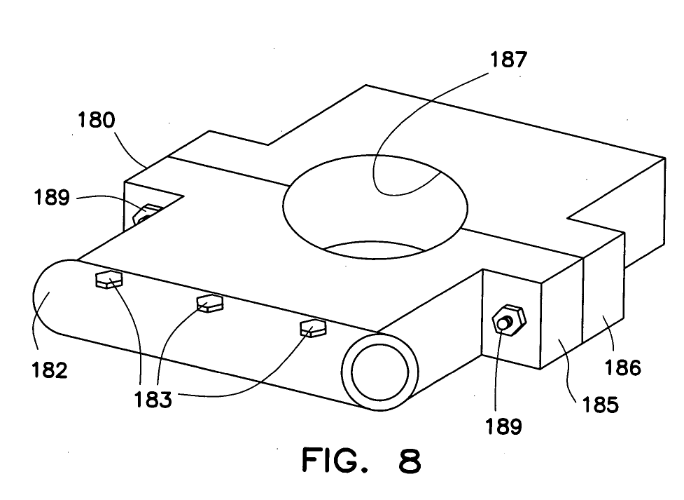

One preferred system for supporting the small diameter steering apparatus 10 is shown in FIGS. 7-8. In this embodiment, a mounting system 140 includes a bar or tube 142 that is mounted to the steering column by way of a mounting bracket 180 (shown in FIG. 8). The mounting bracket 180 includes a mounting cylinder or sleeve 182 through which the mounting bar 142 extends. A plurality of bolts 183 (or comparable fasteners) pass through the sleeve 182 and bar 142 to fix the bar thereto. The bracket 180 is preferably formed by two clamp halves 185,186 which cooperate when combined to form an opening 187. This opening is configured to receive the vehicle steering column in clamped engagement when the two halves are bolted together by fasteners 189. Additional details of this mounting system 140 can be obtained from co-pending application Ser. No. 10/632,543, entitled “Joystick Operated Driving System”, filed on Aug. 1, 2003, in the name of the same inventor. The disclosure of this application (Ser. No. 10/632,543) is incorporated herein by reference, especially FIGS. 2 and 15 and the associated written description thereof.

The mounting system 140 includes a bar 145 that is telescopingly engaged with the bar 140 to move laterally within the vehicle, as shown in FIG. 7. The end of the bar 145 forms a right angle bend to telescopingly receive another bar 147. The bar 147 can move fore and aft within the vehicle cockpit—i.e., closer to or farther away from the driver. Fasteners 146 can be used to fix the relative positions of the telescoping components. The bar 147 is configured to support the small diameter steering apparatus 10 and can be mounted to the housing 16 by a mounting bracket or plate 149 in a known manner. The telescoping bars 145 and 147 allow complete adjustment of the location of the steering apparatus 10 by telescoping and rotating each bar relative to the other bar and the mounting bar 140.

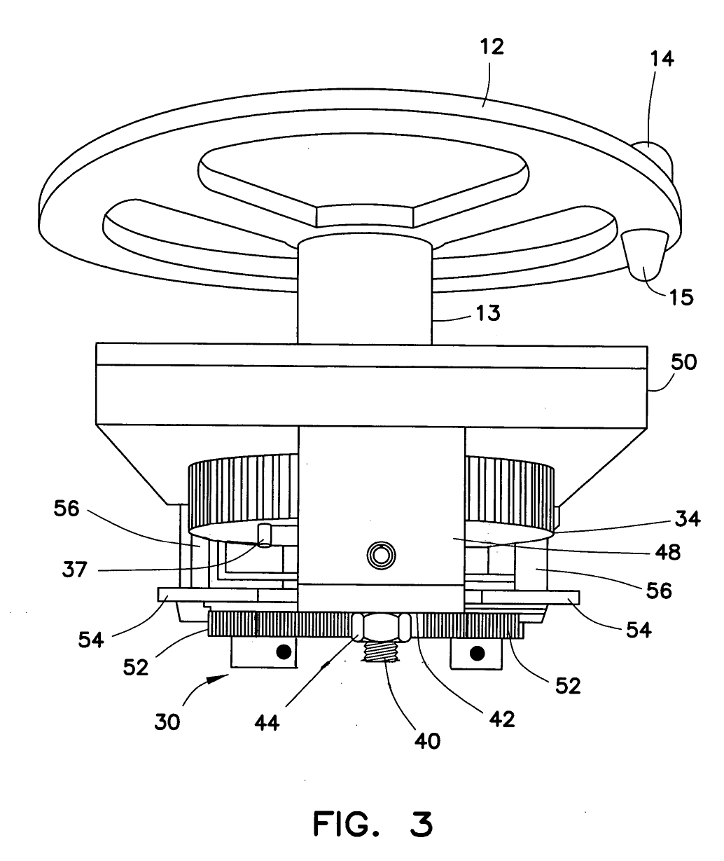

Returning to the description of the steering apparatus itself, the position encoding mechanism 30 of the apparatus 10 can be seen in FIGS. 2-4. The small diameter steering wheel 12 includes a hub 13 that connects to an axle 31 extending into the housing. The axle 31 supports two gears. The first is a steering gear 32 that is used to provide a steering input that is ultimately processed by the controller 22, as described in more detail below.

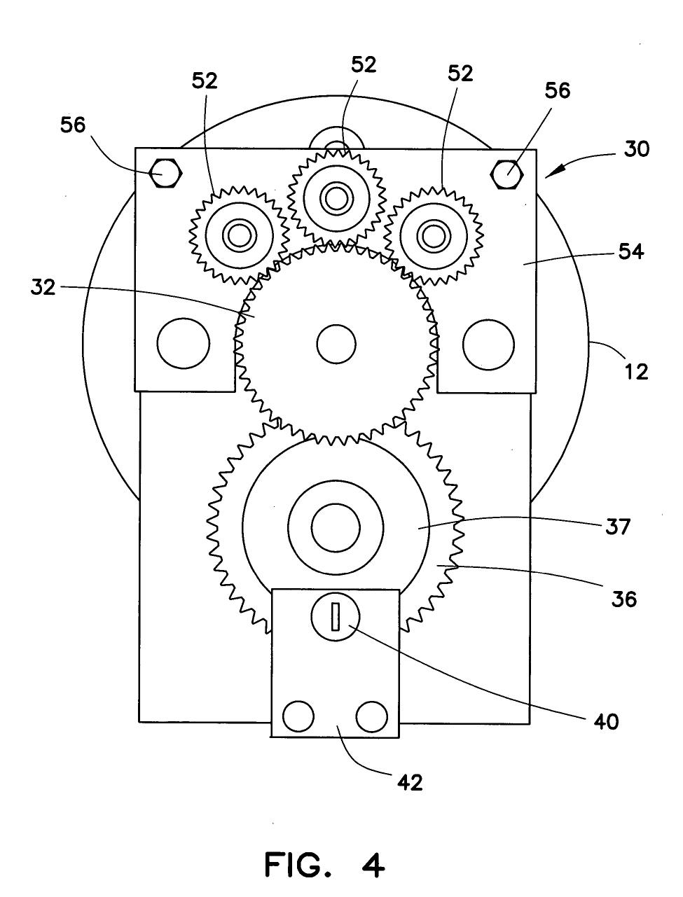

The second is a sensitivity gear 34 that is used to provide a calibratable resistance to rotation of the steering wheel. The sensitivity gear 34 meshes with a reaction gear 36 that is rotatably supported on the cover plate 50 of the housing 16. A pressure screw 40 is threaded into a support plate 42 affixed to the cover plate by a support block 48. The pressure screw is aligned beneath the reaction gear 36 to bear against a reaction surface 37 of the gear 36 (see FIGS. 2 and 4). The pressure screw 40 can be threaded into and out of the support plate 42 to vary the pressure exerted on the reaction surface 37. This pressure leads to frictional resistance to rotation of the reaction gear 36.

In the preferred embodiment, the pressure screw bears against the reaction gear. Alternatively, the pressure screw can bear against another component in the position encoding mechanism, such as the axle 31 or the steering gear 32. However, the reaction gear/pressure screw approach is preferred because the reaction gear adds rotational inertia to the system and because it is easier to calibrate the sensitivity of the frictional resistance.

Preferably, the pressure screw 40 is formed of a polymeric material, such as nylon or polyethylene, so that the screw produces a modest static friction to hold the steering wheel 12 in a particular angular orientation and to offer minimal resistance against movement as the steering wheel is rotated. In addition the pressure screw is configured to offer minimal, but noticeable, resistance due to sliding friction as the steering wheel is turned. Preferably the end of the pressure screw that bears against the reaction gear is slightly rounded.

The amount of resistance to rotation of the steering wheel 12, and hence the amount of effort required to steer, can be calibrated by modifying the pressure exerted by the pressure screw 40. In addition, the effort required steer can also be controlled by the gear ratio between the sensitivity gear 34 and the reaction gear 36. Both parameters can be adjusted when the steering apparatus 10 is installed so that the system is calibrated to the particular driver and his/her physical capabilities or driving preferences. The pressure screw 40 is provided with a pair of locking nuts 44 that bear on opposite sides of the support plate 42 to lock the screw in its calibrated position. Over time, the end of the screw will wear, which may necessitate periodic re-adjustment. Alternatively, the pressure screw can be self-adjusting.

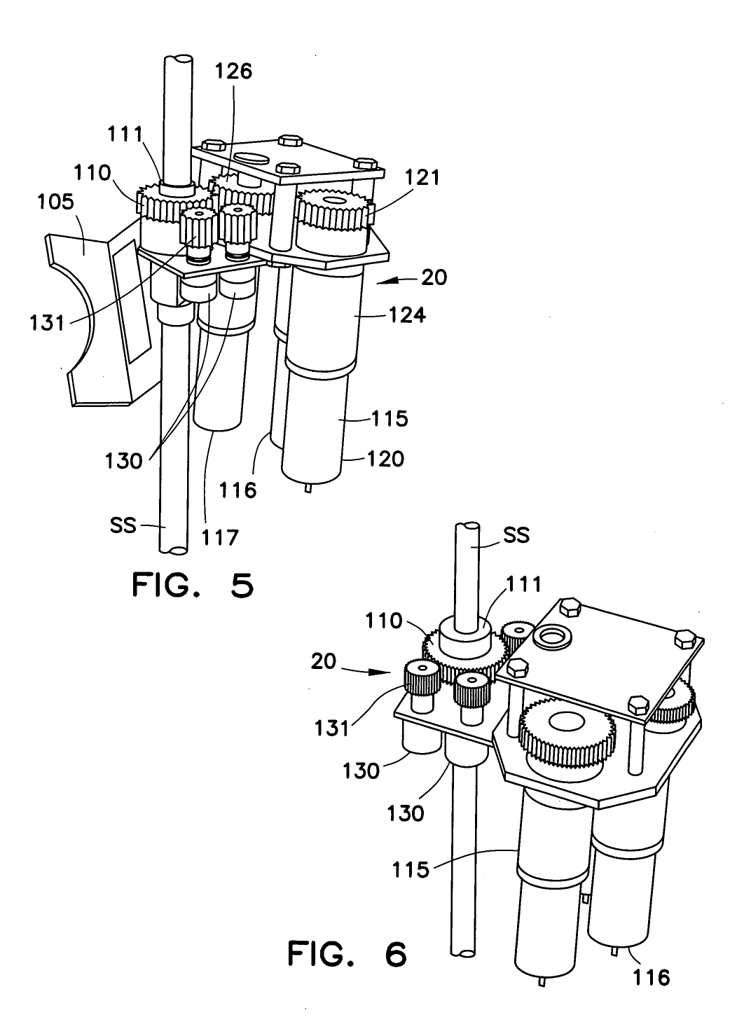

The apparatus 10 includes a stop pin 46 that projects inward from a support block 48 mounted to the cover 50. The stop pin 46 is positioned to be contacted by a stop post 47 that projects downward from the underside of the reaction gear 36. In particular, the stop pin 46 and post 47 prevent rotation of the steering wheel 12 beyond 360°. In this preferred embodiment, a single stop pin is provided. Alternatively, two such pins can be provided that are angularly offset to limit rotation of the steering wheel to less than 360°. The range of rotation of the steering wheel, and consequently the position of the stop(s), is a function of the processor 22 and the manner in which it translates movement of the steering wheel 12 to commands to rotate the steering column SS (see FIGS. 5-6).

The relationship between rotation of the steering wheel 12 and rotation of the steering column SS is determined by the steering driven gears 52 that mesh with the steering gear 32. As best seen in FIG. 4, three such driven gears 52 are provide, each individually meshing with the steering gear 32. The driven gears are rotatably supported on a plate 54 that is attached to the cover plate 50 by mounting posts 56. The gears 32 and 52 are offset from the underside of the cover plate 50 so that position sensors or potentiometers 58 can be supported on the plate 54 (FIG. 2). Each driven gear 52 is connected to a position sensor 58 so that the rotational position of the corresponding gear can be ascertained. Control wires 25 (FIG. 1) communicate between each of the position sensors 58 and the controller 22 to feed the rotational position signals to the controller. (It can be noted that in a preferred embodiment, the control wires 25 pass through the mounting bars 147, 145 and 142 to connect to the controller 22 mounted under the vehicle dashboard). The controller includes software and/or hardware to convert the rotational position signals into a control signal fed on control wires 28 to the steering mechanism 20, which is described in more detail below.

In accordance with one feature of the invention, the steering apparatus 10 most preferably three driven gears 52 and corresponding position sensors 58. Each sensor produces a signal corresponding to the rotational position of its associated driven gear. The same steering gear 32 meshes with and drives each driven gear, so it is expected that each position sensor 58 will register the same rotational position or amount of rotation. However, the present invention contemplates triple redundancy to ensure that no error or failure occurs in translating movement of the steering wheel 12 to a corresponding commanded movement of the steering column SS.

The three rotational position signals fed to the controller 22 can be handled in several ways. One approach is a majority rule approach in which the controller polls the three signals and the signal value common to the majority of the sensors is used to determine the amount of steering applied. A second approach is to average the rotational position signal values among all of the sensors, provided that they all fall with a predetermined range. A third approach is to rely upon the position signal from one sensor, provided that it is within a predetermined range of the signals produced by the other sensors. A polling algorithm can be utilized in which the sensors are polled successively until a common rotational position value is found. Appropriate algorithms and control circuitry and/or software can be incorporated into the controller 22 to generate a steering control signal fed to the steering mechanism 20 on control wires 28. This feature of the invention overcomes the dangers of using a single position sensor, since a failure of the sensor or the driven gear will go undetected. In addition, the triple redundancy feature of the present invention is much better than a two sensor system because in a two sensor system it is problematic to determine which sensor/driven gear has failed when the two sensor signals differ. The present invention provides an optimum redundancy for a fail-safe determination of the amount of steering commanded by the driver.

Details of the steering mechanism 20 are found in FIGS. 5-6. The mechanism is shown mounted on the existing vehicle steering shaft SS. The steering mechanism can be constructed as described in above identified concurrently filed application Ser. No. 10/______, which claims priority to co-pending provisional application No. 60/491,740, entitled “Joystick-Operated Driving System”, filed on Aug. 1, 2003 in the name of the present inventor. The description of the steering mechanism depicted in FIGS. 11-13 of this application is incorporated herein by reference.

In accordance with one aspect of the invention, the mechanism 20 does not require modification of the vehicle steering shaft, so the steering shaft operates in its expected manner to control the steering of the vehicle wheels. This feature is important because it allows a differently abled driver to use the vehicle steering wheel S (FIG. 7) if desired. The steering mechanism 20 is provided with a mounting bracket 105 that allows mounting of the mechanism to existing mounting points of the vehicle. For instance, the bracket can fasten to the dashboard underbody or to the steering column structure surrounding the steering shaft.

The steering mechanism 20 includes a driven gear 110 that is mounted to the steering shaft SS. In a preferred embodiment, the driven gear is mounted by way of a collet or clamp assembly 111 that is clamped to the steering shaft in a conventional manner. The driven gear itself can include a set screw configuration for fastening the steering driven gear 110 to the steering shaft SS.

The driven gear 110 is rotated by three drive assemblies 115, 116, 117. Each drive assembly includes a motor, such as motor 120, that rotates a drive gear 121. Preferably, each motor includes a transmission 124 that is capable of free-wheel operation under circumstances described below. Each of the drive gears, such as gear 121, associated with each drive assembly 115, 116, 117, meshes with an idler gear 126. The idler gear also meshes with the driven gear 110 for rotation of the steering shaft SS.

In another feature of the steering mechanism, a number of potentiometers 130 are provided, with each potentiometer being driven by a gear 131 that meshes with the driven gear 110 used to rotate the steering shaft SS. These potentiometers provide amount of or angle of rotation information to the controller 22 as the steering shaft is being rotated by the drive assemblies 115. This information can be used as input to a steering algorithm that integrates steering information with lateral acceleration data. In addition, the potentiometers can provide interactive information regarding the position of the steering wheel that can be fed back to the microprocessor.

In a further aspect of the invention, the small diameter steering apparatus 10 can be combined with other driving aids for the physically challenged driver. For instance, a hand controller 159 can be used by the driver to control vehicle braking and acceleration. The controller 159 is moved fore and aft to generate control signals fed to the controller 22 (FIG. 1), which in turn sends control signals to an actuator assembly 160. The actuator assembly drives actuators 162 to depress the vehicle's brake pedal B and actuators 164 to depress the vehicle's accelerator pedal A. A preferred hand controller and actuator assembly is described in co-pending patent application Ser. No. 10/632,543, cited above. The specification of this application, and especially its description of the subject components, is incorporated herein by reference.

For the purposes of the present disclosure, the salient feature is that the hand controller 159 can be adjustably supported on the mounting system 140 together with the small diameter steering apparatus 10, as depicted in FIG. 7. In a preferred embodiment, the hand controller includes a housing 157 that is supported on a bar 155. The bar is in telescoping engagement with the mounting rod 142 so that the lateral position of the hand controller can be adjusted. The bar 155 can also incorporate a telescoping feature to adjust the fore-aft location of the controller 159.

As shown in FIG. 7, the mounting system 140 can accommodate both the apparatus 10 for controlling the vehicle steering, and the hand controller 159 for controlling the vehicle braking and acceleration. The two components 10 and 159 are supported clear of the vehicle's steering wheel S, brake pedal B and accelerator pedal A so that another driver is able to use those standard vehicle control features. From the perspective of the physically impaired driver, the mounting system 140 allows complete adjustment of the orientation and location of the driving assist components. While the steering apparatus 10 is shown on the right side of the driver's cockpit, it may just as easily be supported on the left side. The lateral and fore-aft locations of the assist components can be adjusted, as can the angular attitude of the components, all with the objective of positioning the components according to the personal preferences and physical capabilities of the driver.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

1. A steering apparatus for use in a vehicle having a stock steering wheel and steering shaft rotatably coupled to the stock steering wheel, the apparatus comprising:
a steering wheel having a diameter significantly smaller than the diameter of the stock steering wheel;
a position encoding mechanism coupled to said steering wheel and operable to generate a position signal in relation to the amount of rotation of said steering wheel;
a steering mechanism coupled to the vehicle steering shaft including at least one motor configured to rotate the steering shaft in response to a steering command; and
a processor receiving said position signal from said position encoding mechanism and operable to generate said steering command in relation thereto.

2. The steering apparatus of claim 1, wherein said position encoding mechanism includes:
a steering gear connected to said steering wheel to rotate therewith;
at least three driven gears meshed with said steering gear; and
at least three sensors, each coupled to a respective one of said driven gears and operable to generate a position signal in relation to the amount of rotation of the respective driven gear.

3. The steering apparatus of claim 2, wherein said processor is configured to poll said position signal generated by each of said at least three sensors and is operable to produce a single steering command in relation thereto.

4. The steering apparatus of claim 1, wherein said steering wheel includes a knob mounted thereon, said knob being manually graspable to facilitate rotation of said steering wheel.

5. The steering apparatus of claim 1, further comprising a sensitivity mechanism coupled to said steering wheel and operable to produce a resistance to rotation of said steering wheel.

6. The steering apparatus of claim 5, wherein said sensitivity mechanism includes:
a reaction gear coupled to said steering wheel to rotate therewith; and
a pressure element bearing against said reaction gear to frictionally resist rotation of said reaction gear.

7. The steering apparatus of claim 6, wherein said pressure element is a screw mounted relative to said reaction gear to apply an adjustable pressure against said reaction gear.

8. The steering apparatus of claim 1, further comprising:
a housing enclosing said position encoding mechanism; and
a mounting system for mounting said housing within the vehicle for access by the vehicle's driver.

9. The steering apparatus of claim 8, wherein said mounting system includes:
a mounting bar mountable to the vehicle; and
a support bar having one end in telescoping engagement with said mounting bar and another end connected to said housing.

10. A vehicle control system for a vehicle having stock steering, braking and acceleration controls, the control system comprising:
a hand-operated controller operable to generate acceleration and braking signals independent of the stock vehicle braking and acceleration controls;
an actuator assembly coupled to the vehicle stock braking and acceleration controls and operable to manipulate the vehicle stock braking and acceleration controls in response to said acceleration and braking signals;
an auxiliary steering assembly having a steering wheel independent of the vehicle stock steering control and operable to generate a position signal in relation to the amount of rotation of said steering wheel;
a steering mechanism coupled to the vehicle stock steering and operable to manipulate the stock steering in response to said position signal; and
a support assembly for supporting said hand-operated controller and said auxiliary steering assembly within the vehicle while permit access to the vehicle stock steering, braking and acceleration controls.

11. The vehicle control system of claim 10, wherein said support assembly includes:
a mounting bar mountable to the vehicle adjacent the vehicle stock steering control and extending to either side of the steering control;
a first support bar having one end engaged to one end of said mounting bar and another end connected to and supporting said hand-operated controller; and
a second support bar having one end engaged to an opposite end of said mounting bar and another end connected to and supporting said auxiliary steering assembly.

12. The vehicle control system of claim 11, wherein said first support bar is adjustably engaged to said mounting bar to permit adjustment of the position of said hand-operated controller relative thereto.

13. The vehicle control system of claim 12, wherein said second support bar is adjustably engaged to said mounting bar to permit adjustment of the position of said auxiliary steering assembly relative thereto.

14. The vehicle control system of claim 11, wherein said second support bar is adjustably engaged to said mounting bar to permit adjustment of the position of said auxiliary steering assembly relative thereto.

15. The vehicle control system of claim 11, wherein at least one of said first and second support bars is telescopingly engaged with said mounting bar.
